(19) United States
(12) Patent Application Publication
(10) Pub. No.: US 2026/0280002 A1
(43) Pub. Date: Sep. 17, 2026

(54) BATTERY ASSEMBLY

(71) Applicant: Schaeffler Technologies AG & Co. KG, Herzogenaurach (DE)

(72) Inventors: Paul Lindemann, Howard, OH (US); Louis McGrath, Strasburg, OH (US); Victor Norwich, Wooster, OH (US)

(73) Assignee: Schaeffler Technologies AG & Co. KG, Herzogenaurach (DE)

(21) Appl. No.: 19/077,642

(22) Filed: Mar. 12, 2025

(51) Int. Cl. H01M 50/242; H01M 10/42; H01M 10/48; H01M 50/204; H01M 50/682

(52) U.S. Cl. CPC H01M 50/242; H01M 10/425; H01M 10/482; H01M 50/204; H01M 50/682; H01M 2010/4278

(57) ABSTRACT

A battery assembly includes a first endplate, a second endplate, a cell stack disposed between the first endplate and the second endplate, a fluid circuit, and at least one piston disposed between the endplates and operable with the fluid circuit to compress the cell stack.

### FIELD OF THE DISCLOSURE

The present disclosure generally relates to battery assemblies. More specifically, the present disclosure relates to cell stack height management for a battery assembly.

### BACKGROUND OF THE DISCLOSURE

Solid-state battery cells are known.

### SUMMARY OF THE DISCLOSURE

According to a first aspect of the present disclosure, a battery assembly includes a first endplate, a second endplate, a cell stack disposed between the first endplate and the second endplate, a fluid circuit, and at least one piston disposed between the endplates and operable with the fluid circuit to compress the cell stack.

Embodiments of the first aspect of the disclosure can include any one or a combination of the following features:
the first endplate defines a portion of the fluid circuit;
the portion includes an inlet, a chamber in which the at least one piston is moveable, and a passage extending between the inlet and the chamber;
a plate between the at least one piston and the cell stack, wherein the at least one piston is disposed between the plate and the first endplate;
the at least one piston includes a seal and a wall that defines a groove, wherein the seal is disposed in the groove and contacts the first endplate to seal the chamber;
at least one piston includes a plurality of pistons arranged in an array that includes a first row of pistons and a second row of pistons extending parallel to the first row of pistons;
the first endplate defines a first branch and a second branch of the fluid circuit, wherein the first branch extends parallel to the first row, and wherein the second branch extends parallel to the first branch and to the second row;
the fluid circuit is configured to convey fluid to the first branch and the second branch at an equal pressure;
a belt operably coupled with and extending between the first endplate and the second endplate, the belt configured to bias the second endplate toward the first endplate;
each endplate has an outer surface having an at least partially arcuate portion, wherein the belt wraps around the arcuate portion of each outer surface; and
control circuitry configured to control a pressure source to increase fluid pressure against the at least one piston in response to an electrical condition of the battery assembly.

According to a second aspect of the present disclosure, a battery assembly includes a first endplate including an end portion and a tube portion extending from the end portion. The tube portion defines a chamber, and the end portion defines a passage in communication with the chamber. The battery assembly includes a second endplate and a cell stack disposed between the first endplate and the second endplate. At least one piston is movably disposed within the chamber. A position of the at least one piston controls a pressure applied to the cell stack.

Embodiments of the second aspect of the disclosure can include any one or a combination of the following features:
a fluid circuit that includes the passage and the chamber, and wherein the fluid circuit is configured to convey pressurized fluid into the chamber to move the at least one piston;
a plate between the at least one piston and the cell stack, wherein the plate is configured to move and compress the cell stack in response to movement of the at least one piston;
the at least one piston includes a wall that defines a groove, wherein the seal is disposed in the groove and contacts the first endplate to seal the chamber;
at least one piston includes a plurality of pistons arranged in an array that includes a first row of pistons and a second row of pistons extending parallel to the first row of pistons;
the first endplate defines a first branch and a second branch of the fluid circuit, wherein the first branch extends parallel to the first row, and wherein the second branch extends parallel to the first branch and to the second row; and
the fluid circuit is configured to convey fluid to the first branch at a first pressure and to the second branch at the first pressure.

According to a third aspect of the present disclosure, a battery assembly includes a first endplate including an end portion and a tube portion extending from the end portion. The tube portion defines a chamber, and the end portion defines a passage in communication with the chamber. The battery assembly includes a second endplate, a cell stack disposed between the first endplate and the second endplate, and a belt operably coupled with and extending between the first endplate and the second endplate. The belt is configured to bias the second endplate toward the first endplate. A piston is movably disposed within the chamber.

Embodiments of the third aspect of the disclosure can include any one or a combination of the following features:
fluid interacts with the piston in the chamber to apply a pressure to the cell stack.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a battery assembly;

FIG. 2 is an elevational view of the battery assembly of FIG. 1 with a cover of the battery assembly omitted;

FIG. 3 is a cut-away view of the battery assembly of FIG. 1 taken along the plane III-III of FIG. 1 with the cover of the battery assembly omitted; and

FIG. 4 is a cut-away view of the battery assembly of FIG. 2 taken along the plane IV-IV of FIG. 2.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

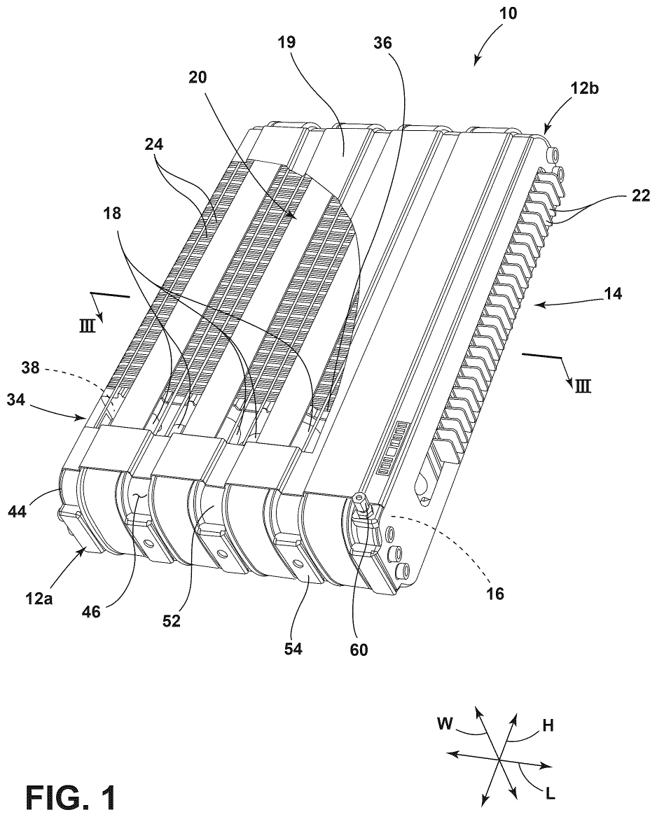

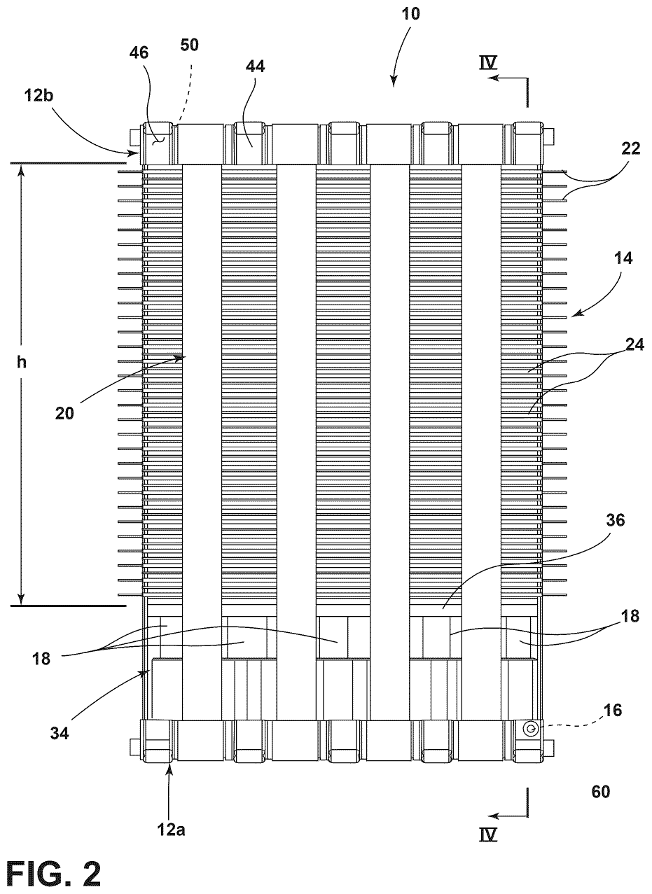

Referring now to FIG. 1-4, a battery assembly is generally indicated at 10. The battery assembly 10 includes a first endplate 12a, a second endplate 12b, a cell stack 14 disposed between the first endplate 12a and the second endplate 12b, and a fluid circuit 16. At least one piston 18 is disposed between the endplates 12a, 12b and is operable with the fluid circuit 16 to compress the cell stack 14.

The battery assembly 10 can include one or more belts 20 operably coupled with and extending between the first endplate 12a and the second endplate 12b. The belt 20 can be configured to bias the second endplate 12b toward the first endplate 12a. A cover 19 (partially shown in FIG. 1) can be disposed over the at least one belt 20.

With continued reference to FIGS. 1-4, the battery assembly 10 can include a battery pack for use in, for example, a vehicular environment. For example, the battery pack can be configured to provide electrical power for one or more components of a vehicle. The at least one cell stack 14 can include one cell stack 14 or a plurality of cell stack 14 distributed between the first endplate 12a and the second endplate 12b. Each cell stack 14 can include a plurality of cells 22 arranged sequentially to define a height of the cell stack 14 (stack height h). Compliant material 24 can be slotted between pairs of adjacent cells 22 to allow for uniformity of pressure on the cell stack 14. The compliant material 24 can provide contact between the cells 22 of the cell stack 14 during this variance. For example, the cells 22 can swell during charging or discharging, thereby causing the stack height h to vary. In some examples, the battery assembly 10 incorporates thermal control via heating mats or cooling loops slotted between cells 22 of the cell stack 14.

The cells 22 can be electrochemical cells, such as battery cells, having a cathode, an anode, and an electrolyte layer disposed therebetween for conducting ions between the cathode and the anode. One or more of the cells 22 can be solid-state batteries that utilize a solid electrolyte layer. In some examples, the liquid or gel electrolyte layers are incorporated into the battery assembly 10. The sequential arrangement of the plurality of cells 22 can be a stacking of a first cathode-electrolyte-anode battery adjacent a second cathode-electrolyte-anode battery.

With continued reference to FIGS. 1-4, the battery assembly 10 can have a height H extending in a first direction along a shortest distance between the pair of endplates 12a, 12b, a length L orthogonal to the height H and extending laterally in a second direction, and a width W orthogonal to the height H and the length L and extending laterally in a third direction orthogonal to the first direction and the second direction. A tension belt system wraps around the first endplate 12a and the second endplate 12b to minimize bending stress. The tension belt system can apply between 0-5 Megapascals (MPa) of contact pressure through each cell stack 14. The tension belt system can include one or more belts 20 that can tension the first and second endplates 12a, 12b toward one another.

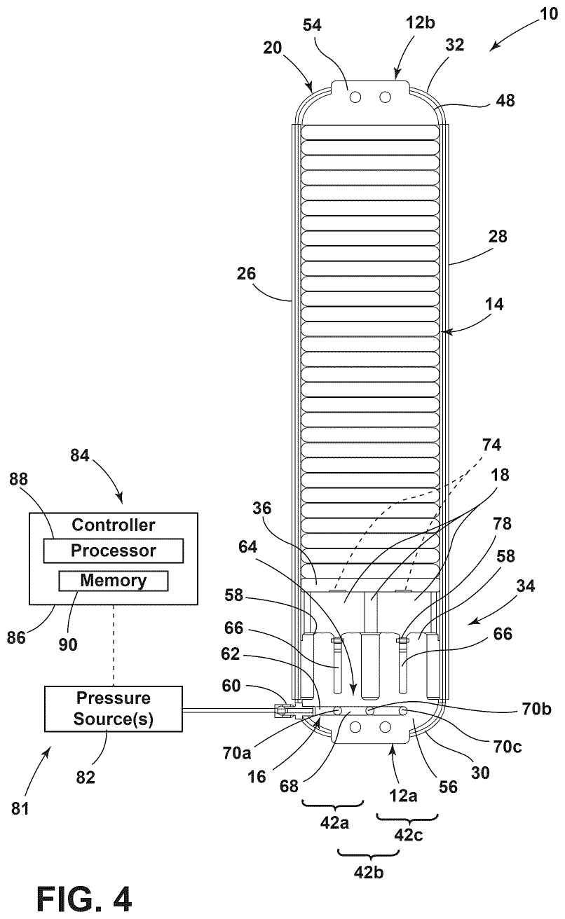

With reference to FIG. 4, detailed portions of each belt 20 are indicated. Each belt 20 includes a first straight portion 26, a second straight portion 28 opposite the first straight portion 26, a first bend portion 30 between the straight portions 26, 28 and extending around the first endplate 12a, and a second bend portion 32 between the straight portions 26, 28 and extending around the second endplate 12b. One or more of the belts 20 can bias the first endplate 12a toward the second endplate 12b, and vice versa. For example, the belts 20 can be in tension to squeeze the first and second endplates 12a, 12b toward one another. In the present example, the straight portions 26, 28 extend along the height H. The tension system can assist in maintaining contact between adjacent cells 22 of the cell stack 14.

With continued reference to FIGS. 1-4, a compression assembly 34 that includes the at least one piston 18 is disposed between the first endplate 12a and the cell stack 14. The compression assembly 34 can provide for displacement during charge/discharge cycles of the cell stack 14. For example, the compression assembly 34 can allow for a 30% expansion of the cell stack 14 that can occur during charging. The compression assembly 34 can include a plate 36 having a rectangular shape. The plate 36 defines a space 38 extending therebetween and in which the at least one piston 18 is disposed. The compression assembly 34 can include a plurality of pistons 18 distributed laterally within the space 38. For example, the pistons 18 can be evenly or unevenly distributed along the width W and length L in the space 38. The plurality of pistons 18 can be arranged in an array. The array can have at least one row 42a, 42b, 42c of pistons 18. In the illustrated examples, a three rows 42a, 42b, 42c of pistons 18 are provided, each extending in a direction of the length L of the battery assembly 10. For example, plane III-III is along the second row 42b, with the third row 42c shown behind the second row 42b. The array of pistons 18 can provide for a balanced application of pressure to the cell stack 14 under while under a squeezing force from the one or more belts 20.

Still referring to FIGS. 1-4, each endplate 12a, 12b can include a body 44 having an outer surface 46, at least a portion of which contacts a belt 20 to form the bend portions 30, 32 around the body 44. At least a portion of each bend portion 30, 32 can extend at an oblique angle relative to the first straight portion 26 and/or the second straight portion 28. For example, the portion of the outer surface 46 can define an arcuate surface 48 engaged by the belt 20 forming an arcuate shape of each bend portion 30, 32. In this way, the first bend portion 30 can engage the body 44 of the first endplate 12a continuously between the first straight portion 26 and the second straight portion 28, and the second bend portion 32 can engage the body 44 of the second endplate 12b continuously between the first straight portion 26 and the second straight portion 28. The curve of the outer surface 46 and the belt 20 can provide enhanced clamping force.

The first and second endplates 12a, 12b can each define a plurality of notches 50 offset lengthwise from one another for receiving the plurality of belts 20. Each notch 50 can form at least a portion of the arcuate surface 48 recessed therein. A width of the notch 50 (extending in a direction of the length of the battery assembly 10) can be within 5% or 10% of a width (extending in a direction of the length L of the battery assembly 10) of the belt 20. The notch 50 can align the belt 20 in the lengthwise direction of the battery assembly 10, such that each belt 20 is retained from sliding along the body 44 outside of the notch 50.

With continued reference to FIGS. 1-4, the body 44 can include a pair of open curved portions 52 interposed by a raised portion 54. The raised portion 54 extends in a direction of the height and defines the notch 50. The open curved portions 52 and the notch 50 can together form the arcuate surface 48 that the belt 20 engages.

One or more of the endplates 12a, 12b can include an end portion 56 and at least one tube portion 58. As exemplarily shown in reference to the first endplate 12a, the at least one tube portion 58 can include a plurality of tube portions 58, each extending from the end portion 56 of the first endplate 12a to form a portion of the compression assembly 34. The compression assembly 34 is configured to interact with a fluid circuit 16 to apply pressure to the cell stack 14. The first endplate 12a forms at least a portion of the fluid circuit 16 via hollows defined by the first endplate 12a. The fluid circuit 16 can be configured to convey pressurized fluid into the chamber 66 to move the pistons 18. By way of example, the fluid pressure can be hydraulic pressure or pneumatic pressure. The fluid may be a liquid or a gas. As shown in FIGS. 1, 2, and 4, a connector 60 is coupled with the first endplate 12a that provides for hydraulic coupling with a pressure management system 81 (FIG. 4).

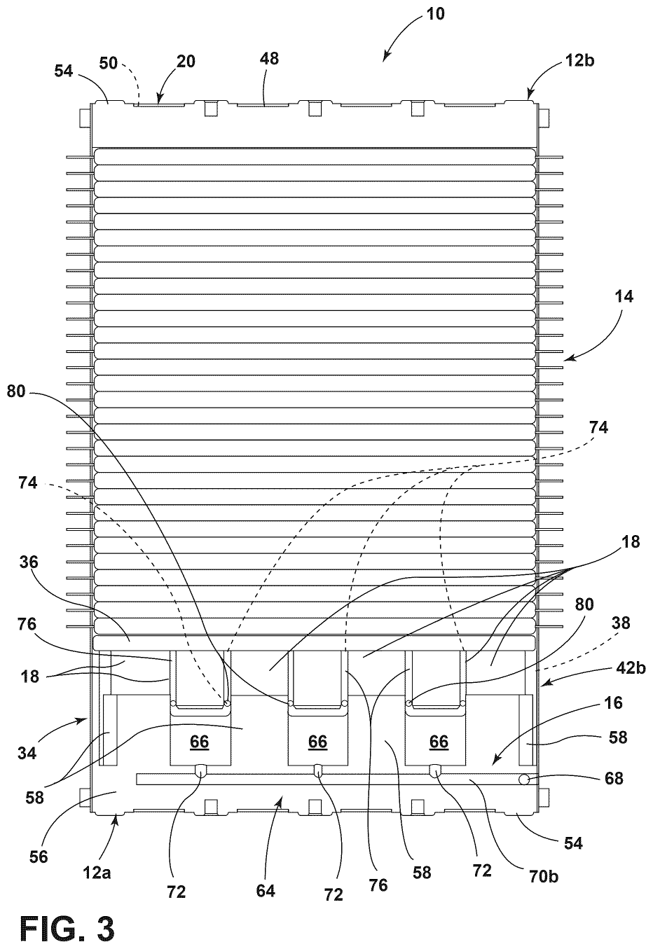

Referring more particularly to FIGS. 3 and 4, the portion of the fluid circuit 16 defined by the first endplate 12a can include an inlet 62, a passage 64, and at least one chamber 66. The inlet 62 and the passage 64 can be defined by the end portion 56, and the at least one chamber 66 can be defined by the at least one tube portion 58. The connector 60 can be coupled with the first endplate 12a adjacent the inlet 62. The passage 64 can include a trunk 68 that extends in a direction of the width and a plurality of branches 70a, 70b, 70c extending from the trunk 68 in a direction of the length. The first endplate 12a can hereby form a manifold among the trunk 68 and the plurality of branches 70a, 70b, 70c. As exemplarily illustrated, the plurality of branches 70a, 70b, 70c can include a first branch 70a, a second branch 70b, and a third branch 70c that each extend parallel to one another along a common level of the height H.

As previously described, the at least one piston 18 can include a plurality of pistons 18 arranged in an array. The branches 70a, 70b, 70c of the passage 64 can correspond to the rows 42a, 42b, 42c of pistons 18 of the array. The second row 42b of pistons 18 is shown in relation to the second branch 70b in FIG. 3, and each branch 70a, 70b, 70c is shown in relation to the plurality of rows 42a, 42b, 42c in FIG. 4.

The first branch 70a extends parallel to the first row 42a, the second branch 70b extends parallel to the first branch 70a and to the second row 42b, and the third branch 70c extends parallel to the first branch 70a, the second branch 70b, and the third row 42c. With reference to FIG. 3, each chamber 66 defined by a tube portion 58 connects with a corresponding outlet 72 of the plurality of branches 70a, 70b, 70c. For example, the first branch 70a can have four outlets 72, with one outlet 72 in fluid communication with a first chamber 66, another outlet 72 in fluid communication with a second chamber 66, and so on. The third branch 70c can follow a similar or different pattern. In the present example, and as shown in FIG. 3, the second branch 70b includes three outlets 72 and three chambers 66.

With continued reference to FIGS. 3 and 4, the compression assembly 34 includes at least one alignment feature for aligning the pistons 18 in the space 38 and with the chambers 66. For example, the plate 36 can define a first groove 74 that is configured to receive an end of a piston 18. By way of example, the first groove 74 can be annular for receiving an annular portion of a cylindrically-shaped piston. Each first groove 74 can laterally align a piston 18.

Each piston 18 can be movably disposed in a chamber 66 defined by a tube portion 58 and include a wall 76 and a seal 78. The wall 76 can be spaced slightly from an inner surface of the tube portion 58 to allow movement of the piston 18 in a direction of the height H. The wall 76 defines a second groove 80 that can receive the seal 78. The second groove 80 can be annularly shaped. The seal 78 can have an annular shape and be disposed in the second groove 80. The seal can span the space 38 to close off the chamber 66 from space 38 between the piston 18 and the tube portion 58. With the chamber 66 as a sealed void, the piston 18 can be moved upward in response to fluid pressure in the chamber 66 and downward against the fluid pressure in response to swelling of the cells 22 of the cell stack 14. Control of the fluid circuit 16 can manage the position of the pistons 18 and/or pressure applied to the cell stack 14.

Referring now to FIG. 4, the battery assembly 10 can include a system 81 configured to manage the fluid circuit 16. For example, the system 81 can be a pressure management system. The system 81 includes one or more pressure sources 82 and control circuitry 84 configured to control the one or more pressure sources 82. The one or more pressure sources 82 can include switching circuitry (e.g., relays, transistors), motors, pumps, valves, actuators, or any combination thereof to pressurize fluid for the fluid circuit 16. For example, the one or more pressure sources 82 can be configured to pressurize liquid or gas to provide hydraulic or pneumatic pressure, as the case may be. While not shown, the control circuitry 84 can monitor a feedback pressure indicative of a pressure of the fluid circuit 16 and control the pressure source 82 based on the feedback pressure.

The control circuitry 84 can include a controller 86 having a processor 88 and a memory 90. The memory 90 can store instructions that, when executed by the processor 88, cause the controller 86 to perform tasks related to control of the battery assembly 10. The control circuitry 84 can be common to or separate from control circuitry 84 for power management of the battery assembly 10. The processor 88 can be any computing unit capable of executing instructions, including a central processing unit (CPU), microcontroller unit (MCU), digital signal processor (DSP), application-specific integrated circuit (ASIC), or field-programmable gate array (FPGA). The controller 86 may be a single-core or multi-core unit and can be integrated into a system-on-chip (SoC) or function as a standalone component.

The memory 90 may comprise any storage medium capable of holding data or instructions for execution by the processor 88. This can include volatile memory, such as random-access memory (RAM), and non-volatile memory, such as read-only memory (ROM), flash memory, electrically erasable programmable read-only memory (EEPROM), or magnetic and optical storage. The memory 90 can store executable program code, configuration data, sensor readings, or other information essential for the controller 86 to carry out operations related to control of a battery assembly 10. The memory 90 and processor 88 may be integrated within a single package or exist as separate components connected via a bus or other communication interface.

The controller 86 may be designed as a standalone hardware device or integrated into a larger system, such as a computer, embedded device, or Internet of Things (IoT) node. The controller 86 can incorporate auxiliary components like communication interfaces, power management units, and analog-to-digital converters (ADCs) to facilitate interactions with external devices or sensors. The processor 88 may run firmware, software, or a combination of both, allowing the controller 86 to execute specific functions, such as processing input signals, executing control algorithms, or managing system resources for operation of a battery assembly 10.

In operation, the system 81 that is configured to manage the fluid circuit 16 can control the fluid circuit 16 to provide fluid into the inlet 62, through the passage 64, and into the chambers 66. Further, the one or more pressure sources 82 of the system 81 can be controlled to pressurize the fluid to control the pistons 18 in the chambers 66. As the pistons 18 press on the plate, the cell stack 14 is pressurized between the plate 36 and the second endplate 12b. The pressure of the fluid can be controlled to allow for expansion/swelling of the cells 22. The pressure of the fluid to maintain contact between the cells 22 of the cell stack 14 during high-current demand events, such as fast-charge events or peak discharge. The height h of the cell stack 14 can be controlled via control of the pressure.

In some implementations, the control circuitry 84 of the system 81 is configured to control operation of one or more pressure sources 82 to control compression of the cell stack 14 via the one or more pistons 18 based on a demand condition pertaining to the battery assembly 10. For example, in an exemplary embodiment, the control circuitry 84 of the system 81 may control the one or more pressure sources 82 to increase fluid pressure against the one or more pistons 18, which in turn causes the one or more pistons 18 to apply increased pressure to the cell stack 14 in response to a relatively high demand condition of the battery assembly 10, such as an elevated demand condition stemming from a period of fast charging or peak discharge of the batter assembly. As such, the system 81, via the control circuitry 84, may manage the fluid circuit 16, such that the piston 18 applies a first amount of force to the cell stack 14 based on a first demand condition of the battery assembly 10, and the piston 18 applies a second amount of force to the cell stack 14 based on a second demand condition of the battery assembly 10. In an exemplary embodiment, a demand associated with the first demand condition is greater than a demand associated with the second demand condition, and the first amount of force is greater than the second amount of force. The control circuitry 84 can control one or more pressure sources 82 to increase fluid pressure against the at least one piston 18 in response to an electrical condition (e.g., a charging condition, a discharging condition, a swelling condition, a contraction condition) of the battery assembly 10.

The battery assembly 10 can provide for a compact on-board vehicle module design. The curved endplates can minimize bending stresses applied to cells 22 during compression to provide a uniform pressure distribution within the cell stack 14. In some aspects, the battery assembly 10 can provide for enhanced energy density via the use of solid-state batteries. The battery assembly 10 can provide for stack height h expansion (e.g., swelling of cells 22, an increased number of cells 22 per stack 14, etc.). The battery assembly 10 may also provide for uniform pressure distribution using the array of pistons 18 of the compression assembly 34.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 battery assembly
12a first endplate
12b second endplate
14 cell stack
16 fluid circuit
18 piston
19 cover
20 belt
22 cell
h stack height
24 compliant material
H height
L length
W width
26 first straight portion
28 second straight portion
30 first bend portion
32 second bend portion
34 compression assembly
36 plate
38 space
42a first row
42b second row
42c third row
44 body
46 outer surface
48 arcuate surface
50 notch
52 open curved portions
54 raised portion
56 end portion
58 tube portion
60 connector
62 inlet
64 passage
66 chamber
68 trunk
70a first branch
70b second branch
70c third branch
72 outlet
74 first groove
76 wall
78 seal
80 second groove
81 system
82 pressure source
84 control circuitry
86 controller
88 processor
90 memory

What is claimed is:

1. A battery assembly, comprising:
a first endplate;
a second endplate;
a cell stack disposed between the first endplate and the second endplate;
a fluid circuit; and
at least one piston disposed between the endplates and operable with the fluid circuit to compress the cell stack.

2. The battery assembly of claim 1, wherein the first endplate defines a portion of the fluid circuit.

3. The battery assembly of claim 2, wherein the portion includes an inlet, a chamber in which the at least one piston is moveable, and a passage extending between the inlet and the chamber.

4. The battery assembly of claim 3, comprising:
a plate between the at least one piston and the cell stack, wherein the at least one piston is disposed between the plate and the first endplate.

5. The battery assembly of claim 4, wherein the at least one piston includes a seal and a wall that defines a groove, wherein the seal is disposed in the groove and contacts the first endplate to seal the chamber.

6. The battery assembly of claim 1, wherein the at least one piston includes a plurality of pistons arranged in an array that includes a first row of pistons and a second row of pistons extending parallel to the first row of pistons.

7. The battery assembly of claim 6, wherein the first endplate defines a first branch and a second branch of the fluid circuit, wherein the first branch extends parallel to the first row, and wherein the second branch extends parallel to the first branch and to the second row.

8. The battery assembly of claim 7, wherein the fluid circuit is configured to convey fluid to the first branch and the second branch at an equal pressure.

9. The battery assembly of claim 1, comprising:
a belt operably coupled with and extending between the first endplate and the second endplate, the belt configured to bias the second endplate toward the first endplate.

10. The battery assembly of claim 9, wherein each endplate has an outer surface having an at least partially arcuate portion, wherein the belt wraps around the arcuate portion of each outer surface.

11. The battery assembly of claim 1, comprising:
control circuitry configured to control a pressure source to increase fluid pressure against the at least one piston in response to an electrical condition of the battery assembly.

12. A battery assembly, comprising:
a first endplate including an end portion and a tube portion extending from the end portion, wherein the tube portion defines a chamber and the end portion defines a passage in communication with the chamber;
a second endplate;
a cell stack disposed between the first endplate and the second endplate; and
at least one piston moveably disposed within the chamber, wherein a position of the at least one piston controls a pressure applied to the cell stack.

13. The battery assembly of claim 12, comprising a fluid circuit that includes the passage and the chamber, and wherein the fluid circuit is configured to convey pressurized fluid into the chamber to move the at least one piston.

14. The battery assembly of claim 13, comprising:
a plate between the at least one piston and the cell stack, wherein the plate is configured to move and compress the cell stack in response to movement of the at least one piston.

15. The battery assembly of claim 14, wherein the at least one piston includes a wall that defines a groove, wherein the seal is disposed in the groove and contacts the first endplate to seal the chamber.

16. The battery assembly of claim 13, wherein the at least one piston includes a plurality of pistons arranged in an array that includes a first row of pistons and a second row of pistons extending parallel to the first row of pistons.

17. The battery assembly of claim 16, wherein the first endplate defines a first branch and a second branch of the fluid circuit, wherein the first branch extends parallel to the first row, and wherein the second branch extends parallel to the first branch and to the second row.

18. The battery assembly of claim 17, wherein the fluid circuit is configured to convey fluid to the first branch at a first pressure and to the second branch at the first pressure.

19. A battery assembly, comprising:
a first endplate including an end portion and a tube portion extending from the end portion, wherein the tube portion defines a chamber and the end portion defines a passage in communication with the chamber;
a second endplate;
a cell stack disposed between the first endplate and the second endplate;
a belt operably coupled with and extending between the first endplate and the second endplate, the belt configured to bias the second endplate toward the first endplate; and
a piston moveably disposed within the chamber.

20. The battery assembly of claim 19, wherein fluid interacts with the piston in the chamber to apply a pressure to the cell stack.
